(19) United States
(12) Patent Application Publication
(10) Pub. No.: US 2016/0267111 A1
(43) Pub. Date: Sep. 15, 2016

(54) TWO-STAGE VECTOR REDUCTION USING TWO-DIMENSIONAL AND ONE-DIMENSIONAL SYSTOLIC ARRAYS

(71) Applicant: MICROSOFT TECHNOLOGY LICENSING, LLC, Redmond, WA (US)

(72) Inventors: Mohammed SHOAIB, Redmond, WA (US); Jie LIU, Medina, WA (US); Swagath VENKATARAMANI, West Lafayette, IN (US)

(21) Appl. No.: 14/715,557

(22) Filed: May 18, 2015

Related U.S. Application Data
(60) Provisional application No. 62/131,814, filed on Mar. 11, 2015.
(60) Provisional application No. 62/131,815, filed on Mar. 11, 2015.

(51) Int. Cl. G06F 17/30

(52) U.S. Cl. CPC G06F 17/30292; G06F 17/30592

(57) ABSTRACT

Examples of the disclosure efficiently processing data sets. In some examples, a plurality of first processor elements process a first data set (e.g., an image) and a second data set (e.g., a kernel) using a first function to generate a third data set. The third data set is processed using a second function to generate an output element. The first processor elements are arranged in a two-dimensional systolic array such that one or more first processor elements receive input from a first adjacent first processor element and transmit output to a second adjacent first processor element. A plurality of second processor elements aggregate the output element to at least partially generate a fourth data set. The plurality of second processor elements arranged in a one-dimensional array. Aspects of the disclosure facilitate increasing speed, conserving memory, reducing processor load or an amount of energy consumed, and/or reducing network bandwidth usage.

### CROSS-REFERENCE TO RELATED APPLICATIONS

This application claims the benefit of U.S. Provisional Application No. 62/131,814, filed Mar. 11, 2015, and of U.S. Provisional Application No. 62/131,815, filed Mar. 11, 2015.

This application is related to Context-Awareness Through Biased On-Device Image Classifiers, filed concurrently herewith and incorporated by reference herein.

This application is related to Methods and Systems for Low-Energy Image Classification, filed concurrently herewith and incorporated by reference herein.

This application is related to Methods and Systems for Generating Enhanced Images Using Multi-Frame Processing, filed concurrently herewith and incorporated by reference herein.

### BACKGROUND

Some operations performed by computing devices are time consuming and/or resource intensive. Known methods of multi-frame processing (MFP), for example, utilize complex calculations that take more than 1.8 seconds per frame and/or utilize dedicated hardware that consumes substantial power. Moreover, at least some known methods retrieve and, in at least some implementations, re-retrieve data from a memory area, which consumes bandwidth each time the data is re-retrieved.

### SUMMARY

Examples of the disclosure process a data set to produce an enhanced data set. In some examples, a system includes a plurality of first processor elements that processes a first data set and a second data set using a first function to generate a third data set, and processes the third data set using a second function to generate an output element. The first processor elements are arranged in a two-dimensional systolic array such that one or more first processor elements of the first plurality of processor elements receive input from one or more first adjacent first processor elements and transmit output to one or more second adjacent first processor elements (e.g., using systolic computation). The system includes a plurality of second processor elements that aggregate the output elements to at least partially generate a fourth data set. The plurality of second processor elements are arranged in a one-dimensional array.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of an example computing device that may be used to process a data set.

FIG. 2 is a block diagram of an example hardware architecture for performing multi-frame processing on a computing device, such as the computing device shown in FIG. 1.

FIG. 3 is a block diagram of an example feature-extraction module that may be used with a hardware architecture, such as the hardware architecture shown in FIG. 2.

FIG. 4 illustrates an example two-level vector reduction that may be implemented using a hardware architecture, such as the hardware architecture shown in FIG. 2.

FIG. 5 is a block diagram of an example systolic array that may be used to implement a two-level vector reduction, such as the two-level vector reduction shown in FIG. 4.

FIG. 6 illustrates an example stage of a two-level vector reduction, such as the two-level vector reduction shown in FIG. 4.

FIG. 7 is a flowchart of an example method for processing a data set using a systolic array, such as the systolic array shown in FIG. 5.

FIG. 8 is a block diagram of an example support vector machine that may be used with a systolic array, such as the systolic array shown in FIG. 5.

Corresponding reference characters indicate corresponding parts throughout the drawings.

### DETAILED DESCRIPTION

The disclosed system includes an architecture configured to perform systolic processing of a data set. For example, a raw image is processed by the architecture using a kernel data set to generate a processed image. The architecture includes a two-dimensional systolic array and a one-dimensional systolic array. Examples of the disclosure processing a first data set using the two-dimensional systolic array and a second data set to generate a third data set. The third data set is processed using a second function to generate an output element. The one-dimensional systolic array is configured to aggregate the output element to at least partially generate a fourth data set.

Aspects of the disclosure facilitate increasing speed, conserving memory, reducing processor load or an amount of energy consumed, and/or reducing network bandwidth usage by calculating one or more values, storing the one or more values in a local buffer, and reusing the one or more values. Local buffering is utilized at various stages of processing to leverage the architectural elements described herein. In some examples, buffering data locally decreases or eliminates the need to re-fetch data from external memory, lowering memory bandwidth and/or local storage used. Additionally or alternatively, fine-grained parallel implementations are used within various processing elements of the accelerator. For example, many blocks involve a series of two-level vector reduction operations. The disclosed system employs arrays of specialized processing elements that are interconnected to exploit this computation pattern.

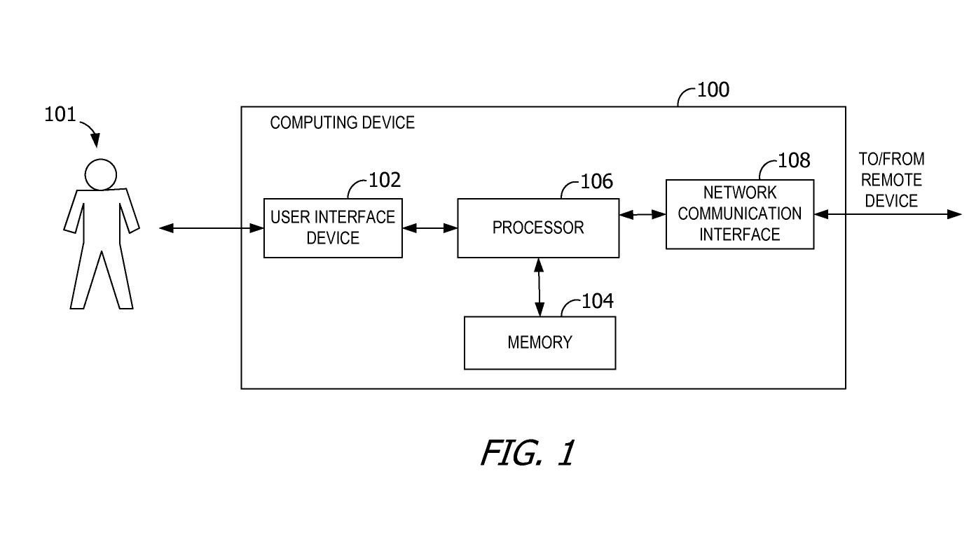

FIG. 1 is a block diagram of a computing device 100 that may be used with the systems described herein. In this example, the computing device 100 is a mobile device. While some examples of the disclosure are illustrated and described herein with reference to the computing device 100 being a mobile device, aspects of the disclosure are operable with any device that generates, captures, records, retrieves, or receives images (e.g., computers with cameras, mobile devices, security systems). For example, the computing device 100 may include a portable media player, mobile telephone, tablet, netbook, laptop, desktop personal computer, computing pad, kiosks, tabletop devices, industrial control devices, wireless charging stations, electric automobile charging stations, and other computing devices. Additionally, the computing device 100 may represent a group of processing units or other computing devices.

A user 101 may operate the computing device 100. In some examples, the computing device 100 may be always on, or the computing device 100 may turn on and/or off in response to stimuli such as a change in light conditions, movement in the visual field, change in weather conditions, etc. In other examples, the computing device 100 may turn on and/or off in accordance with a policy. For example, the computing device 100 may be on during predetermined hours of the day, when a vehicle is on, etc.

The computing device 100, in some examples, includes a user interface device or interface module 102 for exchanging data between the computing device 100 and the user 101, computer-readable media, and/or another computing device. In at least some examples, the interface module 102 is coupled to or includes a presentation device configured to present information, such as text, images, audio, video, graphics, alerts, and the like, to the user 101. The presentation device may include, without limitation, a display, speaker, and/or vibrating component. Additionally or alternatively, the interface module 102 is coupled to or includes an input device configured to receive information, such as user commands, from the user 101. The input device may include, without limitation, a game controller, camera, microphone, and/or accelerometer. In at least some examples, the presentation device and the input device may be integrated in a common user-interface device configured to present information to the user 101 and receive information from the user 101. For example, the user-interface device may include, without limitation, a capacitive touch screen display and/or a controller including a vibrating component.

The computing device 100 includes one or more computer-readable media, such as a memory area 104 storing computer-executable instructions, video or image data, and/or other data, and one or more processors 106 programmed to execute the computer-executable instructions for implementing aspects of the disclosure. The memory area 104 includes any quantity of media associated with or accessible by the computing device 100. The memory area 104 may be internal to the computing device 100 (as shown in FIG. 1), external to the computing device 100 (not shown), or both (not shown).

In some examples, the memory area 104 stores, among other data, one or more applications. The applications, when executed by the processor 106, operate to perform functionality on the computing device 100. Example applications include mail application programs, web browsers, calendar application programs, address book application programs, messaging programs, media applications, location-based services, search programs, and the like. The applications may communicate with counterpart applications or services such as web services accessible via a network. For example, the applications may represent downloaded client-side applications that correspond to server-side services executing in a cloud.

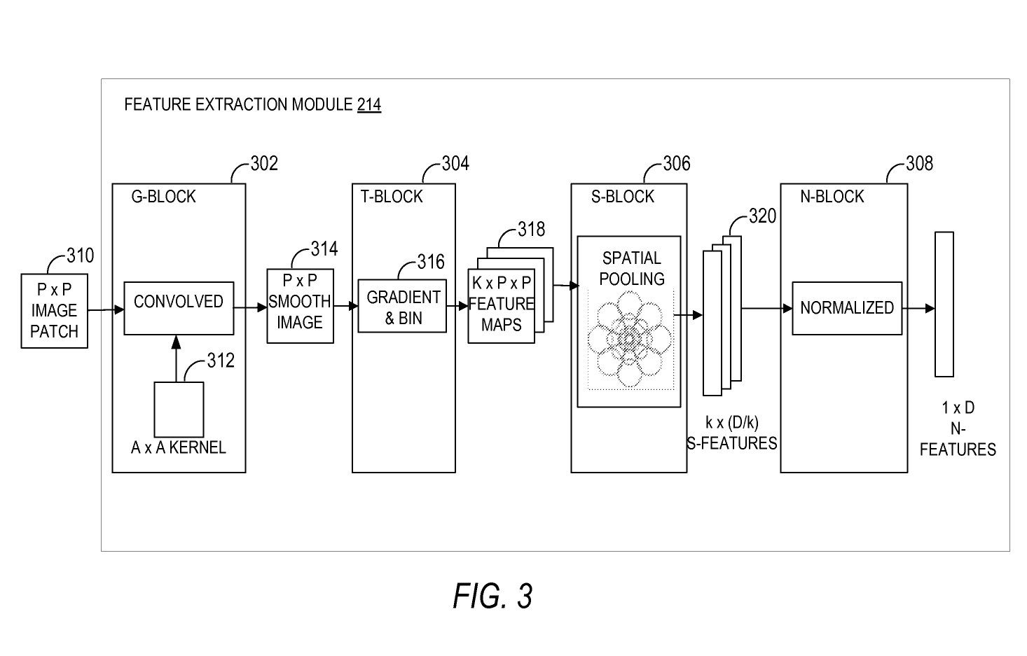

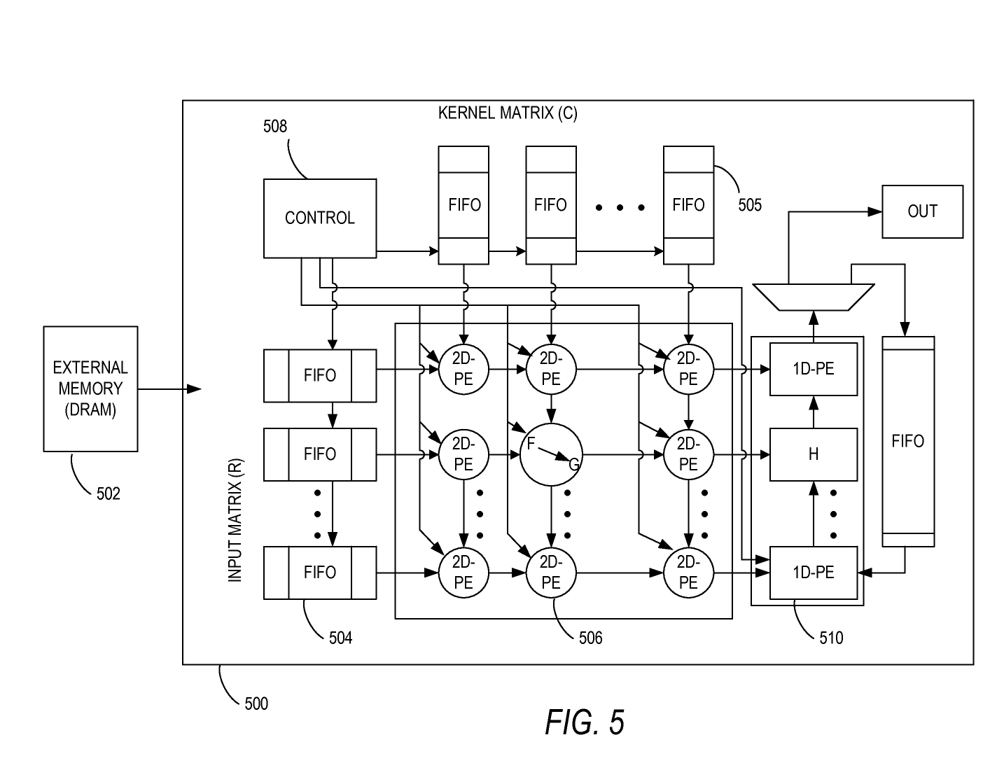

The processor 106 includes any quantity of processing units, and the instructions may be performed by the processor 106 or by multiple processors within the computing device 100 or performed by a processor external to the computing device 100. The processor 106 is programmed to execute instructions such as those illustrated in the figures (e.g., FIGS. 3 and 5).

The processor 106 is transformed into a special purpose microprocessor by executing computer-executable instructions or by otherwise being programmed. For example, the processor 106 may execute the computer-executable instructions to identify one or more interest points in a plurality of images, extract one or more features from the one or more interest points, align the plurality of images, and/or combining the plurality of images. Although the processor 106 is shown separate from the memory area 104, examples of the disclosure contemplate that the memory area 104 may be onboard the processor 106 such as in some embedded systems.

In this example, the memory area 104 stores one or more computer-executable components for multi-frame processing of images. A network communication interface 108, in some examples, exchanges data between the computing device 100 and a computer-readable media or another computing device. The network communication interface 108 may transmit the image to a remote device and/or receive requests from the remote device. Communication between the computing device 100 and a computer-readable media or another computing device may occur using any protocol or mechanism over any wired or wireless connection.

The block diagram of FIG. 1 is merely illustrative of an example system that may be used in connection with one or more examples of the disclosure and is not intended to be limiting in any way. Further, some peripherals or components of the computing device 100 known in the art are not shown, but are operable with aspects of the disclosure. At least a portion of the functionality of the various elements in FIG. 1 may be performed by other elements in FIG. 1, or an entity (e.g., processor, web service, server, application program, computing device, etc.) not shown in FIG. 1.

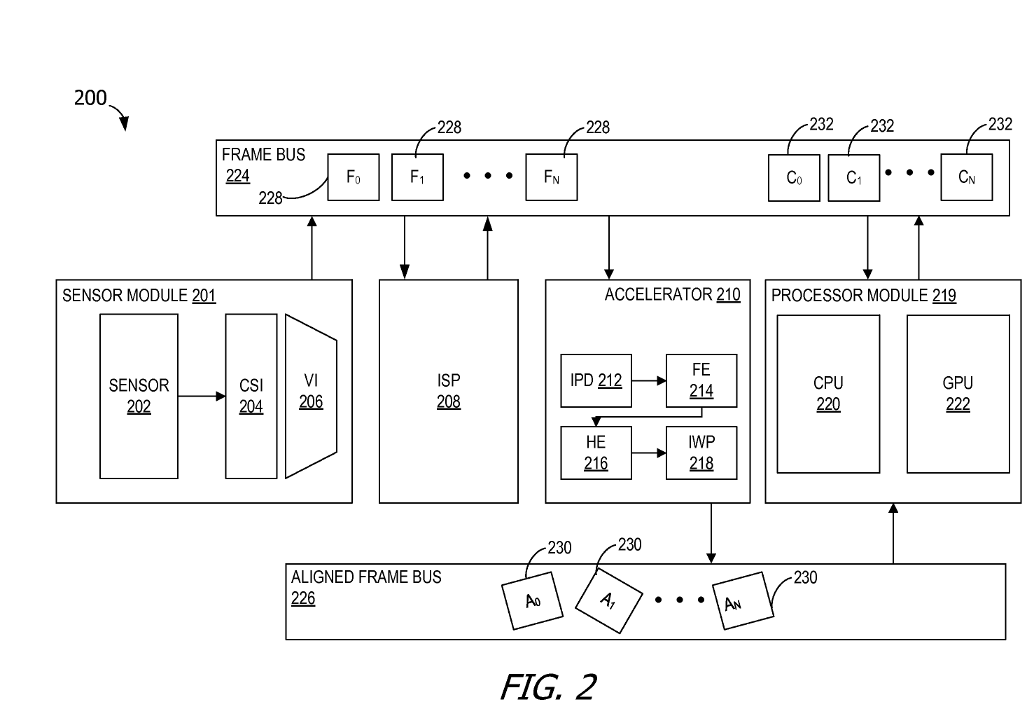

FIG. 2 illustrates a functional block diagram of a hardware architecture on a computing device 200 (e.g., computing device 100) for multi-frame processing. Alternatively, the computing device 200 may use software, firmware, hardware, or a combination thereof to process a plurality of frames. A sensor module 201 includes a sensor 202 and a camera serial interface (CSI) 204 and/or a video interface (VI) 206 coupled to the sensor 202. In some examples, the sensor 202 is configured to capture one or more raw images 228 or frames of video, which are transmitted through the CSI 204 and/or VI 206 and transmitted to or placed onto a first frame bus (e.g., frame bus) 224. Additionally or alternatively, raw images 228 are captured elsewhere and placed onto the first frame bus 224.

An image signal processor (ISP) 208 is configured to retrieve or pull down one or more raw images 228 from the first frame bus 224 and clean up or otherwise process the raw images 228. The ISP 208 may place one or more processed images onto the first frame bus 224 (raw images 228 and processed images are represented as F₀, F₁ . . . F_{N} in FIG. 2)

An accelerator 210 is configured to retrieve or pull down one or more images 228 from the first frame bus 224 and align the images 228. The accelerator 210 may place one or more aligned images 230 onto a second frame bus (e.g., aligned frame bus) 226. In some examples, the accelerator 210 includes an interest point-detection (IPD) module 212, a feature-extraction (FE) module 214, a homography estimation (HE) module 216, and/or an image warping (IWP) or warp module 218. Alternatively, the accelerator 210 may include any combination of modules that enables the computing device 200 to function as described herein.

The IPD module 212 may retrieve or take one or more images 228 from the first frame bus 224 and detect, identify, or search for one or more relevant interest points on the images 228. Interest-point detection helps identify pixel locations associated with relevant information. Examples of pixel locations include closed-boundary regions, edges, contours, line intersections, corners, etc. In one example, corners are used as interest points because corners form relatively robust control points and/or detecting corners has a relatively low computational complexity. The FE module 214 may extract one or more features from the interest points using, for example, a daisy feature-extraction algorithm. The HE module 216 may align or shift one or more images 228 such that the images utilize the same or a common coordinate system. The IWP module 218 warps, modifies, or adjusts one or more images 228 such that the images 228 are aligned. One or more aligned images 230 are placed on the aligned frame bus 226.

A processor module 219 includes a central processing unit (CPU) 220 and/or a graphics processing unit (GPU) 222 configured to retrieve or pull down one or more aligned images 230 from the aligned frame bus 226 and combine or composite the images and place the composite images 232 onto the first frame bus 224. In at least some examples, the CPU 220 and/or GPU 222 are interchangeable.

Images 228 are consumed by the accelerator 210 and are replaced on the first frame bus 224 by the processor module 219 with composite images 232. In at least some examples, raw images 228 are consumed by the ISP 208 and are replaced on the first frame bus 224 by the ISP 208 with processed images. This consumption and/or replacement process enables the first frame bus 224 to run at or below capacity. In some examples, the computing device 200 includes a third bus onto which the processor module 219 places the composite images 232. In some examples, one or more frame buses 224 and 226 are alternating, non-colliding, or isolated. This reduces an opportunity for an element of the architecture from being starved and/or from acting as a bottleneck to another element of the architecture. In this example, one or more frame buses 224 and 226 are connected to an application or another output, for instance, on a mobile device. In some examples, the frame buses 224 and 226 are connected to an output using a multiplexer.

FIG. 3 shows a block diagram of a feature-extraction (FE) module 214 configured to implement the feature-extraction algorithm, such that one or more low-level features may be extracted from pixels around the interest points (e.g., the corners identified in the interest point-detection operation).

Typical classification algorithms use histogram-based feature-extraction methods, such as scale-invariant feature transform (SIFT), histogram oriented gradient (HoG), gradient location and orientation histogram (GLOH), etc. The FE module 214 enables a computation engine using a modular framework to represent or mimic many other feature-extraction methods depending on tunable algorithmic parameters that may be set at run-time. As shown in FIG. 3, the feature-extraction module includes a G-Block 302, a T-Block 304, an S-Block 306, an N-Block 308, and in some examples an E-Block.

In some examples, different candidate blocks are swapped in and out to produce new overall descriptors. In addition, parameters that are internal to the candidate features may be tuned in order to increase the performance of the descriptor as a whole. In this example, the FE module 214 is pipelined to perform stream processing of pixels. The feature-extraction algorithm includes a plurality of processing steps that are heavily interleaved at the pixel, patch, and frame levels.

In a first block or filter module, the FE module 214 includes a pre-smoothing or G-Block 302 that is configured to smooth a P×P image patch of pixels 310 around each interest point by convolving it with a two-dimensional Gaussian filter of standard deviation (σₛ). In one example, it is convolved with a kernel having dimensions A×A 312. This results in a smoothened P×P image patch of pixels 314. The number of rows and/or columns in the G-Block 302 may be adjusted to achieve a desired energy and throughput scalability.

In a second block or gradient module, the FE module 214 includes a transformation or T-Block 304 that is configured to map the P×P smoothened patch of pixels 314 onto a length k vector with non-negative elements to create k×P×P feature maps 318. At a high level, the T-Block is a single processing element that generates the T-Block features sequentially. There are four sub-blocks defined for the transformation, namely, T1, T2, T3, and T4 (collectively illustrated as “Gradient and Bin” 316).

In sub-block T1, at each pixel location (x, y), the disclosure computes gradients along both horizontal (Δx) and vertical (Δy) directions. The magnitude of the gradient vector is then apportioned into k bins (where k equals 4 in T1a and 8 in T1b mode), split equally along the radial direction—resulting in an output array of k feature maps, each of size P×P.

In sub-block T2, the gradient vector is quantized in a sine-weighted fashion into 4 (T2a) or 8 (T2b) bins. For T2a, the quantization is done as follows: |Δₓ|−Δₓ; |Δₓ|+Δₓ; |Δ_{y}|−Δ_{y}; |Δ_{y}|+Δ_{y}. For T2b, the quantization is done by concatenating an additional length 4 vector using Δ₄₅ D45, which is the gradient vector rotated through 45 degrees.

In sub-block T3, at each pixel location (x, y), steerable filters are applied using n orientations, and the response is computed from quadrature pairs. Next, the result is quantized in a manner similar to T2a to produce a vector of length k=4n (T3a), and in a manner similar to T2b to produce a vector of length k=8n (T3b). In some examples, filters of second or higher-order derivatives and/or broader scales and orientations are used in combination with the different quantization functions.

In sub-block T4, two isotropic difference of Gaussian (DoG) responses are computed with different centers and scales (effectively reusing the G-block 302). These two responses are used to generate a length k=4 vector by rectifying the positive and negative parts into separate bins as described in T2.

In one example, only the T1 and T2 blocks are utilized. For example, the data path for the T-block includes gradient-computation and quantization engines for the T1 (a), T1 (b), T2 (a), and T2 (b) modes of operation. In another example, T3 and T4 are also utilized. In some examples, various combinations of T1, T2, T3, and T4 are used to achieve different results. The T-block outputs are buffered in a local memory of size 3×(R+2)×24b and the pooling region boundaries are stored in a local static random-access memory (SRAM) of size Np×3×8b.

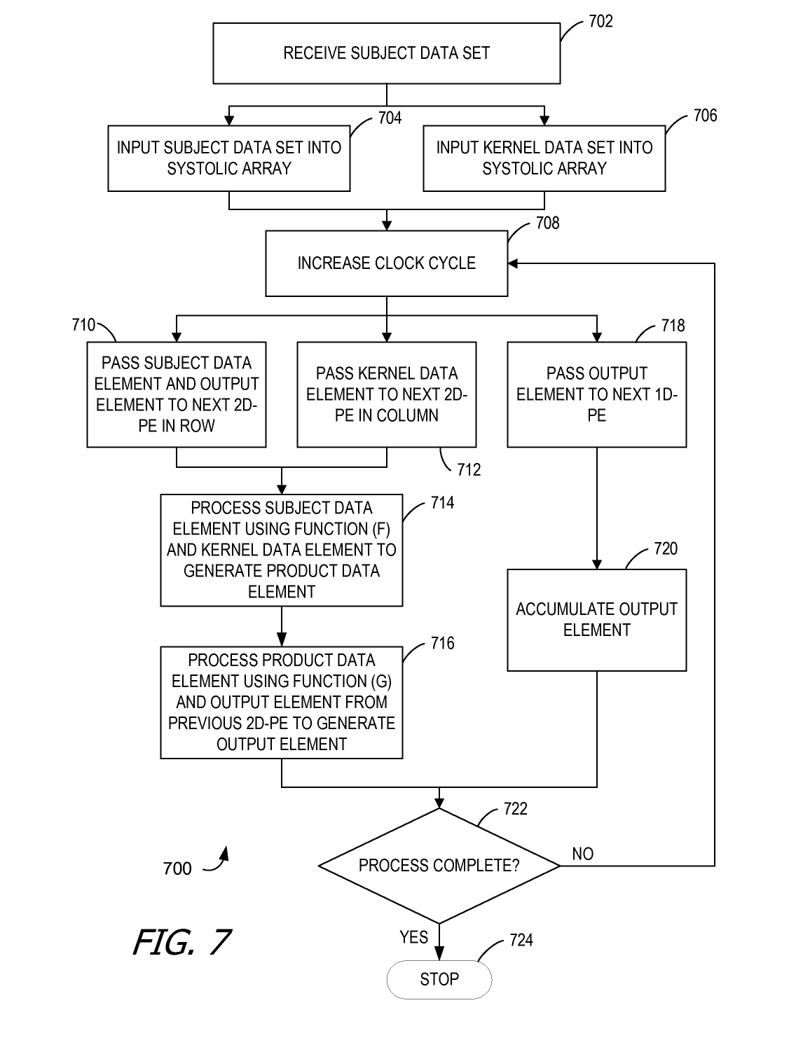

In a third block or pooler module, the FE module 214 includes a spatial pooling or S-Block 306 configured to accumulate the weighted vectors, the k×P×P feature maps 318, from the T-Block 304 to give N linearly summed vectors of length k 320. These N vectors are concatenated to produce a descriptor of length kN. In the S-Block 306, there are a configurable number of parallel lanes for the spatial-pooling process. These lanes include comparators that read out Nₚ pooling region boundaries from a local memory and compare with the current pixel locations. The power consumption and performance of the S-Block 306 may be adjusted by varying a number of lanes in S-Block 306. FIG. 7 illustrates various pooling patterns which are utilized in the S-Block 306 depending on the desired result.

In the final block or normalizer module, the FE module 214 includes a post normalization or N-Block 308 that is configured to remove descriptor dependency on image contrast. The output from the S-block 306 is processed by the N-block 308, which includes an efficient square-rooting algorithm and division module (based on CORDIC). In a non-iterative process, the S-Block 306 features are normalized to a unit vector (e.g., dividing by the Euclidean norm) and all elements above a threshold are clipped. The threshold is defined, in some examples, depending on the type of ambient-aware application operating on the mobile device or, in other examples, the threshold is defined by policies set by a user (e.g., user 101), the cloud, and/or an administrator. In some examples, a system with higher bandwidth, or more cost effective transmission, may set the threshold lower than other systems. In an iterative process, these steps repeat until a predetermined number of iterations has been reached.

Data precisions are tuned to increase an output signal-to-noise-ratio (SNR) for most images. The levels of parallelism in the system, the output precisions, memory sizes etc. may all be parameterized in the code. Assuming no local data buffering between the IPD module 212 and FE modules 214, the feature-extraction block (for nominal ranges) consumes (assuming 64×64 patch size and 100 interest points) approximately 1.2 kB (4×4 two-dimensional array and 25 pooling regions) for a frame resolution of VGA (128×128 patch size and 100 interest points) and approximately 3.5 kB (8×8 two-dimensional array and 25 pooling regions) for a frame resolution of 720p HD. Local buffering between the IPD module 212 and FE module 214 enable those elements to work in a pipelined manner and, thus, mask the external data access bandwidth. Estimated storage capacities for the IPD module 212 and FE modules 214 are approximately 207.38 kB for VGA, 257.32 kB for 1080p, and approximately 331.11 kB for 4k image resolutions.

### Architecture for Two-Stage Vector Reduction

In some examples, vector data may be processed in two stages utilizing two-dimensional-processing elements in a systolic array alongside an array of one-dimensional-processing elements. For example, the G-Block 302 may process images utilizing this two stage approach. The processing elements of the array iteratively process data, passing the results of any computations to the nearest neighbors of each processing element. In this example, an image is processed by a kernel, or type of filter, using this hardware architecture, resulting in a more efficient, faster processing of images on a device. A processing element or a computational unit may be any device or unit that takes an input and produces an output. Examples of processing elements may be implemented in hardware using gates and realized using field-programmable gate arrays or application-specific integrated circuits.

At least some of the modules described herein may utilize or incorporate a two-level vector reduction. In some examples, vector data, such as images, may be processed in two stages utilizing two-dimensional-processing elements in a systolic array alongside an array of one-dimensional-processing elements. The processing elements of the array iteratively process data, passing the results of any computations to the nearest neighbors of each processing element. In this example, an image is processed by a kernel, or type of filter, using this hardware architecture, resulting in a more efficient, faster processing of images on a device.

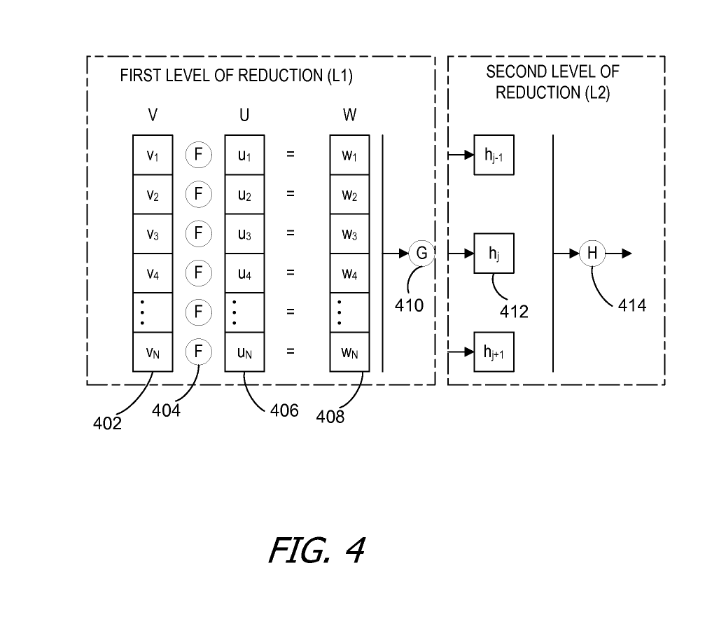

FIG. 4 illustrates the two-stage reduction more generally. In FIG. 4, data set U 406 is associated with an image patch, and data set V 402 is associated with a kernel or filter. Examples of possible filters include Gaussian filters, uniformly distributed filters, median filter, or any other filter known in the art. The data sets U 406 and/or V 402 are stored, for example, in memory area 104. Additionally or alternatively, the data sets U 406 and/or V 402 are received in a transmission from an external source. Additionally or alternatively, the data sets U 406 and/or V 402 are input from an attached device such as a camera or sensor 202.

Utilizing a systolic array enables parallel processing, in two levels of reduction, of the data set U 406. Although the illustrated examples relate to processing images and/or image patches, any data sets may be processed in a systolic array in this manner. In the first level of reduction (e.g., L1), data sets U 406 and V 402 are processed element-wise using a first reduction function F 404. To achieve this, inter-vector data parallelism is utilized, which enables allowing the data set V 402 to be reused across all L1 lanes. The systolic array is utilized to perform the operations and/or to reduce resource costs.

As an example, in a first level of reduction, the first element of data set V 402 is applied to the first element of data set U 406 using function F 404, which yields the first element of data set W 408. In one example, the function F 404 is multiplication and, thus, the vector W 408 is generated by multiplying each element of vector V 402 (for instance, [v₁, v₂, . . . v_{N}]) by the corresponding element of vector U 406 (for instance, [u₁, u₂, . . . u_{N}]). Specifically, in this example, v₁×u₁=w₁, v₂×u₂=w₂, and so on until all elements of data set V 402 have been multiplied by all elements of data set U 406 resulting in a complete data set W 408 ([w₁, w₂, . . . w_{N}]), which has the same number of elements as data sets V 402 and U 406.

In the second level of reduction (e.g., L2), each element wⱼ of the resultant data set W 408 is processed by a second reduction function G 410 to generate an element hⱼ 412. In one example, the function G 410 is an accumulator and/or addition and, thus, the element hⱼ is a scalar product. In this example, the element hⱼ is equal to the sum of w₁+w₂+ . . . +w_{N}. The element hⱼ is generated for each image patch of an image including a plurality of image patches to generate a resultant data set H=[h₁, h₂, hⱼ . . . h_{M}] 414.

When processing overlapping image patches, elements of the data set H 414 and/or and operations associated with generating the elements of the data set H 414 may be interleaved or reused to facilitate decreasing or eliminating the need to recalculate and/or re-fetch data repeatedly from external memory, lowering both memory bandwidth and local storage used.

Various combinations of functions are contemplated for the operations described above. In one example, function F 404 is multiplication and, thus, data set W 408 is the element-wise product of data sets U 406 and V 402. In that example, function G 410 may be addition or accumulation, in which case element hⱼ is the scalar product. In another example of clustering, function F 404 is a distance and, thus, data set W 408 is a distance map of data sets U 406 and V 402 from a centroid. In that example, function G 410 is a comparator, in which case element hⱼ is the nearest neighbor. In another example of image processing, function F 404 is an average and, thus, data set W 408 includes the mean filtered (by data set V 402) pixels of an image patch associated with data set U 406. In that example, function G 410 is a threshold, in which case element hⱼ is an edge location of pixels. In another example of image processing, function F 404 is a gradient and, thus, data set W 408 includes the smoothed filtered (by data set V 402) pixels of an image patch associated with data set U 406. In that example, function G 410 is an addition, in which case element is a dominant optical flow of objects in the image. Although the disclosure is drawn to images, it is understood that the disclosure is not limited to images, but it may also be utilized to process other information such as tags, points in space, generic vectors, etc.

FIG. 5 illustrates a systolic array architecture 500 for implementing the two level vector reduction described above more efficiently. The systolic array architecture 500 allows data to be fed input from an external memory 502 a limited number of times (e.g., once) and reused, which reduces a bandwidth consumed from accessing the external memory 502. In addition to the reduction in consumed bandwidth, the systolic array architecture 500 uses shorter length metallic interconnects and, thus, consumes less power than a conventional processing system. The systolic array architecture 500 includes a systolic array of two-dimensional-processing elements (2d-PE) 506, which may include small multiply-accumulate (MAC) units and internal registers for fast-laning. The 2d-PEs 506 are arranged in rows and/or columns, and each element of an input data set (e.g., data set U 406) is associated with a respective row, and each element of a kernel data set (e.g., data set V 402) is associated with a respective column. In this example, there are R number of first-in, first-out (FIFO) rows 504 for the input data set, and there are C number of FIFO columns 505 for the kernel data set.

The disclosed systolic array architecture 500 provides the benefits discussed herein, feeding inputs a limited number of times, reusing data, and/or reducing bandwidth consumed as a result of accessing external memory 502. Further, the vector reduction process allows the system to perform two-dimensional convolution along any direction, with varying stride lengths, and kernel sizes. For example, the systolic array architecture 500 may retrieve or receive data from the external memory 502 a limited number of times (e.g., once), and process or reduce the data locally at the systolic array architecture 500 without transmitting data to or retrieving additional data from the external memory 502.

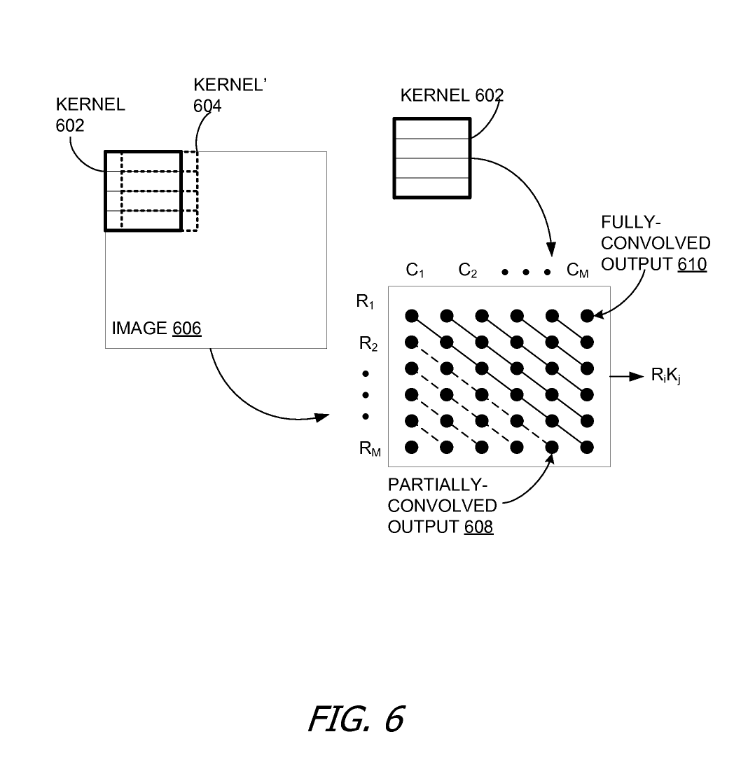

In at least some examples, a control 508 manages an operation and/or a schedule (e.g., clock cycle) of the systolic array architecture 500. On a first clock cycle, element u₁ associated with the first row is transmitted to a 2d-PE 506 positioned on the first row, first column, and element v₁ associated with the first column is transmitted to the 2d-PE 506 positioned on the first row, first column. The F 404 and G 410 functions are implemented at the 2d-PE 506 positioned on the first row, first column (e.g., 2d-PE₁₁) to generate element w₁₁ (e.g., w₁₁=v₁×u₁, and h₁=w₁₁). On each clock cycle, the elements are transmitted to adjacent 2d-PEs 506. For example, on a second clock cycle, one or more relevant elements (e.g., element u₁) are transmitted to an adjacent 2d-PE 506 positioned on the first row, second column (e.g., 2d-PE₁₂), and one or more relevant elements (e.g., element v₁) are transmitted to an adjacent 2d-PE 506 positioned on the second row, first column (e.g., 2d-PE₂₁), where they are processed with an element u₂. For example, at 2d-PE₁₂, element u₁ is processed with element v₂ (e.g., w₁₂=v₂×u₁, and h₁=v₁×u₁+v₂×u₁), and at 2d-PE₂₁, element u₂ is processed with element v₁ (e.g., w₂₁=v₁×u₂, and h₂=w₂₁). After N-clock cycles, 2d-PE_{1N} generates element h₁ (e.g., h₁=v₁×u₁+v₂×u₁+ . . . v_{N}×u₁), and 2d-PE_{2(N-1)} generates element h2 (e.g., h₂=v₁×u₂+v₂×u₂+ . . . v_{(N-1)}×u₂), and so on. Accordingly, at any given point in time, the systolic array includes some combination of fully- and partially-convolved outputs. As shown in FIG. 6, an m×m kernel (e.g., Gaussian filter) is iteratively applied to an n×n image to generate a smoothened image.

At least a part of some of the outputs are reused, as at least some elements are re-fed into the engine by passing them from one processing element to its neighbors. In order to accommodate the partially-convolved outputs, a set of one-dimensional processing elements (1d-PEs) 510 is used along the edge of the 2d-PEs 506. The set of 1d-PEs 510 is, in some examples, arranged in a column, as illustrated in FIG. 5. Early in the process, the output of at least some of the 2d-PEs 506 is zero. As the systolic array architecture 500 continues to operate, the systolic array architecture 500 will be more fully convolved at later clock cycles.

The functions performed by the systolic array architecture 500 may be any operation that enables the system to function as described herein. The advantage of passing relevant elements to adjacent or near neighbor 2d-PEs 506 is that the computations are localized and sequential, thereby increasing an opportunity to reuse at least some elements and/or reducing a latency. This system is configurable to any image or kernel size, stride, type, etc.

In some examples, the systolic array architecture 500 may be modified to include any quantity of 2d-PEs 506 and/or 1d-PEs 510 in any quantity of lanes (e.g., increase or decrease a quantity of rows, increase or decrease a quantity of columns). In this manner, the systolic array architecture 500 may be tailored to scale up or scale down a throughput of the systolic array architecture 500. For example, a rate at which the output element and/or the fourth data set are generated may be modified. In at least some examples, modifying the systolic array architecture 500 enables an amount of power consumed by the systolic array architecture 500 to be managed or controlled. This may be implemented using power gating transistors, clock gating, distributed power supplies etc.

FIG. 6 illustrates one example of how the system described herein may be utilized. As shown in FIG. 6, a kernel 602 is “passed over” an image 606, one patch of pixels at a time. The kernel 602, which may be associated with a filter, operates on one patch of pixels, then it shifts to the right by some predetermined amount, for instance one column of pixels to the right. The kernel 602 passes over the entire first row of the image in this manner, shifting over one column of pixels at a time, then it shifts down one row of pixels, and beings again at the left-hand-side of the image 606.

As shown in FIG. 6, the initial position of the kernel 602 is illustrated in solid black, and labeled KERNEL 602. The kernel 602 is then shifted slightly to the right, and the shifted kernel 602 is illustrated in a dashed line and labeled KERNEL′ 604. In some examples, the shift may be more than a column of pixels. The shift size is variable depending on system parameters. This slight shift in processing results in a largely overlapping area as the kernel 602 shifts to the right. Thus, the systolic array architecture 500 may reuse the output from the first round of computations, and may calculate only the new column of pixels at the edge of the image 606.

The output is stored in local memory to further reduce the latency of the processing. As shown in FIG. 6, the elements along the diagonal include a desired output that will be available after CM cycles. T patches (of size P×P and centered at locations specified in the IPD output FIFO) are read out from external memory in blocks of pixels. In this example, each iteration includes R inputs, takes (R+CM) cycles, and produces R outputs. Initially, output generated by the systolic array architecture 500 is only partially convolved 608. As the systolic array architecture 500 progresses through the clock cycles, at least some output becomes fully convolved 610. Full and partial convolvedness is illustrated by the solid and dashed diagonal lines between elements of the systolic array architecture 500.

Memory consumption associated with the block are RCd×8b for input/output FIFOs of depth d (e.g., 16) and PC×24b to store partially convolved outputs. If pixels are re-fetched from external memory, the hardware consumes an external memory bandwidth of TP2×8b. However, in this example, local buffers are added between the IPD module and the feature-extraction blocks to reduce an opportunity for re-fetching.

FIG. 7 is a flowchart of a method 700 for processing a subject data set (e.g., first data set, data set U) using the systolic array architecture 500. While described with reference to using the systolic array architecture 550 to execute the operations illustrated in FIG. 7, aspects of the disclosure contemplate execution of one or more of the operations by any computing device. At 702, the systolic array architecture 500 receives the subject data set. In some examples, the subject data set is associated with one or more raw images. However, the systolic array architecture 500 may process any data sets fed into it. The subject data set is input into one or more first-in, first-out (FIFO) rows 504 of the systolic array architecture 500 at 704, and the kernel data set (e.g., second data set, data set V) is input into one or more FIFO columns 505 of the systolic array architecture 500 at 706. In some examples, the kernel data set is associated with a filter. Alternatively, the kernel data set may be used to process or reduce the subject data set in any manner that enables the systems to function as described herein.

A clock cycle may be initiated by, for example, increasing a clock cycle at 708. Alternatively, the clock cycle may be increased after the data set(s) have been processed (e.g., at the end of the clock cycle). At 710, a subject data element (e.g., element u₁) is transmitted or passed from a FIFO row 504 towards a first processor element (e.g., a 2d-PE 506), and, at 712, a kernel data element (e.g., element v₁) is transmitted or passed from a FIFO column 505 towards the first processor element. At 714, the subject data element is processed using a first function (e.g., function F) and the kernel data element to generate a product data element (e.g., third data set element, w₁₁), and, at 716, the product data element is processed using a second function (e.g., function G) to generate an output element (e.g., h). Because each 2d-PE 506 accepts one product data element and one kernel data element at a time (e.g., per clock cycle), this results in an element by element processing of the subject data set by the kernel data set. In at least some examples, the 2d-PE 506 may generate the output element based at least in part on an output element received from a previous, adjacent 2d-PE 506 (e.g., from another 2d-PE to the left of the 2d-PE).

In at least some examples, one or more 2d-PEs 506 in the last column (e.g., 2d-PE_{xN}) may transmit or pass an output element to an adjacent 1d-PE at 718. Additionally or alternatively, a 1d-PE may transmit or pass an output element to a subsequent, adjacent 1d-PE (e.g., to another 1d-PE above of the 1d-PE) and/or a FIFO stack, which feeds an output element into the 1d-PE in the last row. At 720, the output elements are aggregated (e.g., accumulated) at the 1d-PE array to generate an output data set (e.g., fourth data set, data set H).

At 722, it is determined whether the process is complete. For example, the control 508 may determine whether all elements of the subject data set have been passed through the systolic array and/or all elements of the output data set have been aggregated. When the process is determined to be complete, the process ends at 724. As shown in FIG. 6, at least one output data set is complete and, in at least some examples, one or more output data sets may be partially convolved for use with a subsequent subject data set.

When the process is determined to be not complete, the process continues by increasing a clock cycle at 708. During this new clock cycle, subject data elements and/or output elements are transmitted or passed down the row towards a subsequent, adjacent 2d-PE 506 at 710, and kernel data elements are transmitted or passed from the column towards a subsequent, adjacent 2d-PE 506 at 712 such that another output element may be generated at one or more 2d-PEs 506. In this way, each 2d-PE 506 may sequentially process a plurality of subject data elements using one kernel data element or process one subject data element sequentially using a plurality of kernel data elements.

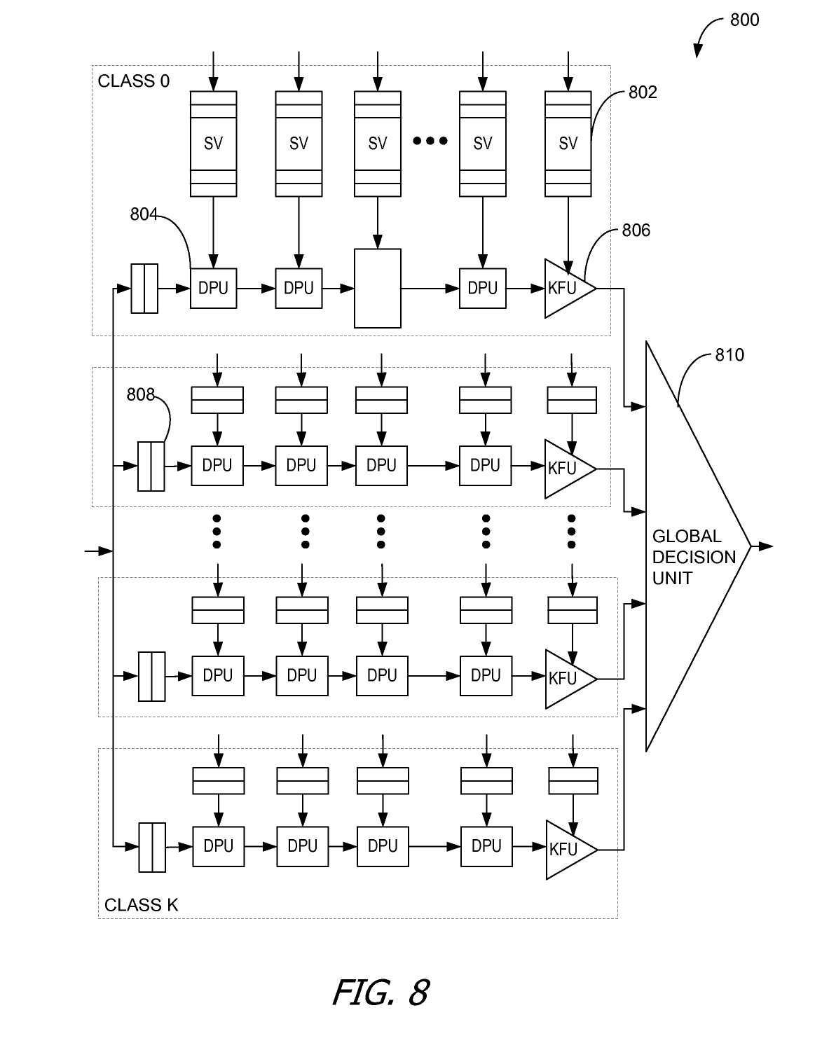

FIG. 8 is a block diagram of a support vector machine (SVM) 800 utilizing a systolic array (e.g., systolic array architecture 500) to implement feature classification algorithms so that relevant frames may be detected or identified. The SVM 800 includes two types of processing elements (PEs), namely, the dot-product unit (DPU) 804 and the kernel-function unit (KFU) 806. The DPUs 804 corresponds to the 2d-PEs 506 in FIG. 5. The KFUs 806 correspond to the 1d-PEs 610 in FIG. 5.

The DPU 804 and/or the KFU 806 realize a distance computation. Support vectors 802, which represent the trained model, or in some examples the kernel 602, kernel matrix, filter matrix, or kernel data set, are stored in a streaming memory bank along the borders of the DPU 804 array. During on-line classification, the DPUs 804 perform L1 vector reduction (illustrated in more detail in FIG. 4 and described above) between the feature descriptors or vectors 808 and the support vectors 802 to compute the dot products. The feature vectors 808 correspond, in some examples, to the input data set, the raw image 606, or the input matrix.

After this, the dot products are streamed out to the KFU 806, where the kernel function (representing the L2 reduction, illustrated in more detail in FIG. 4 and described above) and the distance score is computed. In some examples, only linear and polynomial kernels are utilized. In other examples, other kernels are used. Finally, the distance score is used by the global decision unit (GDU) 810 to compute the classifier output. Each of the previous operations is independent and may be parallelized, such as in the systolic array architecture 500 illustrated in FIG. 5 and described above. The execution time of the SVM 800 is proportional to the number of DPU 804 units (SVM lanes).

### Example Environment

Example computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this disclosure are not signals per se. Example computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an example computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from a user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special-purpose computing device when configured to execute the instructions described herein.

The examples illustrated and described herein as well as examples not specifically described herein but within the scope of aspects of the disclosure constitute example means for processing a data set. For example, the elements described herein constitute at least an example means for generating an image, an example mans for applying a first function to a first data set using a second data set to generate a third data set, and an example means for applying a second function to a third data set to generate an output element, and/or an example means for aggregating an output element to at least partially generate a fourth data set.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The phrase “one or more of the following: A, B, and C” means “at least one of A and/or at least one of B and/or at least one of C.” Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

Alternatively or in addition to the other examples described herein, examples include any combination of the following:
a plurality of first processor elements configured to process a first data set and a second data set using a first function to generate a third data set;
a plurality of first processor elements configured to process a third data set using a second function to generate an output element′
a plurality of first processor elements arranged in a two-dimensional systolic array such that one or more first processor elements of the first plurality of processor elements are configured to receive input from one or more first adjacent first processor elements and transmit output to one or more second adjacent first processor elements;
a plurality of second processor elements configured to aggregate an output element to at least partially generate a fourth data set;
a plurality of second processor elements arranged in a one-dimensional array;
a sensor module configured to generate one or more images, and transmit the one or more images towards a plurality of first processor elements;
a second data set associated with a filter;
a plurality of first processor elements configured to retrieve a first data set from a memory area, the first data set and a third data set processed locally at the system without transmitting data to or retrieving additional data from the memory area;
a plurality of first processor elements arranged in a plurality of rows, each row of the plurality of rows associated with a respective element of the first data set;
a plurality of first processor elements are arranged in a plurality of columns, each column of the plurality of columns associated with a respective element of the second data set;
a first processor element configured to sequentially process a plurality of elements included in a first data set;
a first processor element configured to process a first element sequentially using a plurality of second elements included in a second data set;
a first processor element configured to generate an output element per clock cycle;
processing a first data set and a second data set using a first function to generate a third data set;
processing a third data set using a second function to generate an output element;
aggregating an output element to at least partially generate a fourth data set;
generating one or more images associated with a first data set;
retrieving a first data set from a memory area;
locally processing a first set and a third data set at a processor module without transmitting data to or retrieving additional data from a memory area;
sequentially processing a plurality of elements included in a first data set;
processing a first element sequentially using a plurality of second elements included in a second data set;
generating an output element per clock cycle;
modifying the plurality of first processor elements and/or the plurality of second processor elements to modify a rate at which the output element and/or the fourth data set are generated;
a first processor array configured to apply a first function to a first data set using a second data set to generate a third data set;
a first processor array configured to apply a second function to a third data set to generate an output element;
a second processor array configured to aggregate an output element to at least partially generate a fourth data set;
a first processor array configured to retrieve a first data set from a memory area, the first data set and a third data set processed locally at a mobile device without transmitting data to or retrieving additional data from the memory area;
the first processor array arranged in a plurality of rows and a plurality of columns, each row of the plurality of rows associated with a respective element of one or more first data sets, and each column of the plurality of columns associated with a respective element of the second data set;
a processor element configured to sequentially process a plurality of elements included in a first data set; and
a processor element configured to process a first element sequentially using a plurality of second elements included in a second data set.

In some examples, the operations illustrated may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

What is claimed is:

1. A system comprising:
a plurality of first processor elements configured to process a first data set and a second data set using a first function to generate a third data set, and process the third data set using a second function to generate an output element, the plurality of first processor elements arranged in a two-dimensional systolic array such that one or more first processor elements of the plurality of first processor elements are configured to receive input from one or more first adjacent first processor elements and transmit output to one or more second adjacent first processor elements; and
a plurality of second processor elements configured to aggregate the output element to at least partially generate a fourth data set, the plurality of second processor elements arranged in a one-dimensional array.

2. The system of claim 1, further comprising a sensor module configured to capture data corresponding to one or more images, and transmit the one or more images towards the plurality of first processor elements, the first data set associated with the one or more images.

3. The system of claim 1, wherein the second data set is associated with a filter.

4. The system of claim 1, wherein the plurality of first processor elements are configured to retrieve the first data set from a memory area, the first data set and the third data set processed locally at the system without transmitting data to or retrieving additional data from the memory area.

5. The system of claim 1, wherein the plurality of first processor elements are arranged in a plurality of rows, a first row of the plurality of rows associated with a first element of the first data set.

6. The system of claim 1, wherein the plurality of first processor elements are arranged in a plurality of columns, a first column of the plurality of columns associated with a first element of the second data set.

7. The system of claim 1, wherein one or more first processor elements of the plurality of first processor elements are configured to sequentially process a plurality of elements included in the first data set.

8. The system of claim 1, wherein one or more first processor elements of the plurality of first processor elements are configured to process a first element included in the first data set sequentially using a plurality of second elements included in the second data set.

9. The system of claim 1, wherein one or more of the plurality of first processor elements and the plurality of second processor elements are modifiable to modify a rate at which one or more of the output element and the fourth data set are generated.

10. A method of processing a data set using a processor module including a two-dimensional array and a one-dimensional array, the two-dimensional array including a plurality of first processor elements, the one-dimensional array including a plurality of second processor elements, the method comprising:
processing, at the two-dimensional array, a first data set and a second data set using a first function to generate a third data set, one or more processor elements of the two-dimensional array receiving input from one or more first adjacent processor elements of the two-dimensional array and transmitting output to one or more second adjacent processor elements of the two-dimensional array;
processing, at the two-dimensional array, the third data set using a second function to generate an output element; and
aggregating, at the one-dimensional array, the output element to at least partially generate a fourth data set.

11. The method of claim 10, further comprising generating, at a sensor module, one or more images associated with the first data set.

12. The method of claim 10, further comprising:
retrieving the first data set from a memory area; and
locally processing the first data set and the third data set at the processor module without transmitting data to or retrieving additional data from the memory area.

13. The method of claim 10, wherein processing a first data set comprises sequentially processing a plurality of elements included in the first data set.

14. The method of claim 10, wherein processing a first data set comprises processing a first element included in the first data set sequentially using a plurality of second elements included in the second data set.

15. The method of claim 10, wherein processing the third data set comprises generating, at one or more processor elements of the two-dimensional array, a respective output element per clock cycle.

16. A mobile device comprising:
a sensor module configured to capture data corresponding to an image;
a memory area storing computer-executable instructions for processing a first data set associated with the image;
a first processor array configured to execute the computer-executable instructions to:
apply a first function to the first data set using a second data set to generate a third data set; and
apply a second function to the third data set to generate an output element, one or more processor elements of the first processor array configured to receive input from one or more first adjacent processor elements and transmit output to one or more second adjacent processor elements; and
a second processor array configured to execute the computer-executable instructions to aggregate the output element to at least partially generate a fourth data set.

17. The mobile device of claim 16, wherein the first processor array is configured to retrieve the first data set from a memory area, the first data set and the third data set processed locally at the mobile device without transmitting data to or retrieving additional data from the memory area.

18. The mobile device of claim 16, wherein the first processor array is arranged in a plurality of rows and a plurality of columns, one or more rows of the plurality of rows associated with a respective element of one or more first data sets, and one or more columns of the plurality of columns associated with a respective element of the second data set.

19. The mobile device of claim 16, wherein one or more processor elements of the first processor array are configured to sequentially process a plurality of elements included in the first data set.

20. The mobile device of claim 16, wherein one or more processor elements of the first processor array are configured to process a first element included in the first data set sequentially using a plurality of second elements included in the second data set.
